(19) United States
(12) Patent Application Publication
(10) Pub. No.: US 2012/0233187 A1
(43) Pub. Date: Sep. 13, 2012

(54) METHOD AND APPARATUS FOR DECODING AND READING TXT FILE

(75) Inventor: Yi Chang, Shandong (CN)

(73) Assignee: HISENSE MOBILE COMMUNICATIONS TECHNOLOGY CO., LTD., Shandong (CN)

(21) Appl. No.: 13/508,390

(22) PCT Filed: Apr. 30, 2010
(86) PCT No.: PCT/CN10/00614

§ 371 Date: May 7, 2012

(30) Foreign Application Priority Data
Nov. 19, 2009 (CN) 200910230163.8
Nov. 19, 2009 (CN) 200910230164.2

(51) Int. Cl. G06F 17/30

(52) U.S. Cl. 707/755; 707/E17.009

(57) ABSTRACT

A method and apparatus for decoding and reading a txt file are provided, and the reading method comprises: virtually dividing the txt file into several file blocks in accordance with the set macro value; according to the reading order, loading the file blocks in turn and decoding the contents of the file blocks; in accordance with the displaying requirement, performing the paging process for the decoded file blocks and storing the page table information thereof; for the pages needed to be read, invoking the interface function of Brew platform and displaying them according to the stored page table information.

### CROSS REFERENCE TO RELATED APPLICATIONS

The present application is a US National Stage of International Application No. PCT/CN2010/000614, filed Apr. 30, 2010, designating the United States, and claiming priorities to Chinese Patent Application Nos. 200910230164.2 and 200910230163.8 both filed 19 Nov. 2009.

### FIELD

Embodiments of the present invention relate to the field of terminal devices and particularly to a method and device for decoding a Txt file, an electronic product including the device, a method and device for reading a Txt file based upon a Brew platform, and a reader.

### BACKGROUND

At present, users are increasingly demanding for handheld terminals in terms of their text reading and Txt file decoding functions, but particularly low- to mid-end terminals are generally exposed to an operated Txt file with a restricted capacity of the file due to a limited memory size or like.

On one hand, an operation of decoding, reading or like can not be performed on a Txt file going beyond a hardware restriction of a terminal, a portable electronic product, etc., and a user himself has to fragmentize the file into a plurality of files for an operation of decoding, reading or like which may incur inconvenience to an access of the user; and on the other hand, the Txt file has an increasing capacity and contains an increasing amount of information and there is an increasingly exigent demand for reading such a large-capacity file in the context of currently proliferating information, and also due to an increase in the capacity of the file, the user has to perform increasing varieties of page up or down operations, jumping, etc., and therefore an application of a traditional method and reader for reading a Txt file and a method and device for decoding a Txt file have been unable to accommodate current and future fundamental demands and common operations of the user.

Furthermore there are many items of third-party software for terminal-like electronic book applications, but the majority thereof are third-party software based upon a JAVA platform; and these items of software also have the restriction and functional drawbacks mentioned above, and there is a lack of electronic book applications for a Brew platform.

Moreover different Txt files are generated in different systems. Characters of texts generated in the currently predominant Window system, Apple MAC system and Linux system are stored differently, which incurs such a problem that a Txt file may not be recognized sufficiently upon being transported between systems' platforms.

In general, the existing Txt file decoding and electronic book applications primarily suffer from the following problems:

1. The size of a target file has been restricted or a large-capacity file has been opened slowly.

2. Various codes and different platform text file formats have been parsed insufficiently.

Furthermore the electronic book applications further suffer from the following problems:

3. Neither adjusting of a display effect, e.g., various display modes of a font size, foreground and background colors, an underline, etc., nor arbitrary jumping or browsing can be performed so that diversified operation processes can not be performed on a read file.

### SUMMARY

In view of the foregoing, embodiments of the invention are intended to better address the foregoing problems present in decoding of a Txt file in a portable electronic product by proposing a method and device for decoding a Txt file and an electronic product including the device, and embodiments of the invention are intended to address the foregoing problems present in reading of a text in a handheld terminal by proposing a method and reader for reading a Txt file based upon a Brew platform.

An embodiment of the invention provides a method for decoding a Txt file including:

an operation ‘a’ of virtually dividing a Txt file into several file blocks by a preset macro value; and

an operation ‘b’ of loading the file blocks sequentially in an order of being decoded and decoding contents of the file blocks.

After the operation ‘b’, the method further includes an operation of ‘c’:

paginating the decoded file blocks and storing their page table information.

Before paginating the decoded file blocks, the operation ‘c’ further includes:

an operation ‘c1’ of fetching the decoded file blocks and transcoding the contents of the file blocks into Unicode characters; and

an operation ‘c2’ of performing a line-breaking process upon detection of a CR or an LF in the Unicode characters of the file blocks.

The Txt file is encoded of a type of one or more of:

GB2312/GBK, Unicode, Unicode-BE and Utf-8.

The file blocks are processed in a thread which is terminated after the file blocks are decoded and/or paginated and stored.

An embodiment of the invention provides a device for decoding a Txt file including:

a file block processing module configured to virtually divide a Txt file into several file blocks by a preset macro value; and

a content decoding module configured to load the file blocks output from the file block processing module sequentially in an order of being decoded and decode contents of the file blocks.

The decoding device further includes a content pagination module configured to paginate the file blocks decoded by the content decoding module and to store their page table information.

The content pagination module is further configured to:

fetch the decoded file blocks and transcode the contents of the file blocks into Unicode characters; and

perform a line-breaking process upon detection of a CR or an LF in the Unicode characters of the file blocks.

An embodiment of the invention further provides an electronic product including the decoding device according to the second aspect of the embodiments of the invention.

The electronic product is a cellular phone, an electronic dictionary, a PDA, an MP3 or an MP4.

The advantageous effects of the embodiments of the invention lie in that the embodiments of the invention decode an existing Txt file and further address the restriction on the size of the text file and also perform adaptive encoding and parsing on the target file without any addition cost of hardware.

An embodiment of the invention provides a method for reading a Txt file based upon a Brew platform including:

an operation ‘a’ of virtually dividing a Txt file into several file blocks by a preset macro value;

an operation ‘b’ of loading the file blocks sequentially in an order of being read and decoding contents of the file blocks;

an operation ‘c’ of paginating the decoded file blocks according to a display demand and storing their page table information; and

an operation ‘d’ of invoking an interface function of a Brew platform and displaying a page to be read dependent upon the stored page table information

After the operation ‘c’ and before the operation ‘d’, the method further includes an operation ‘e’ of:

determining whether a start position of the page to be read goes beyond of a range of contents of the currently read file block; and

if so, then going to the operation ‘d’;

otherwise, going back to the operation ‘b’ and performing the subsequent operations again.

The file blocks are processed from the operation ‘b’ in a thread which is terminated after the file blocks are decoded, paginated and stored.

Before paginating the decoded file blocks, the operation ‘c’ further includes:

an operation ‘c1’ of fetching the decoded file blocks and transcoding the contents of the file blocks into Unicode characters; and

an operation ‘c2’ of performing a line-breaking process upon detection of a CR or an LF in the Unicode characters of the file blocks.

An embodiment of the invention provides a Txt file reader based upon a Brew platform including:

a file block processing module configured to virtually divide a Txt file into several file blocks by a preset macro value;

a content decoding module configured to load the file blocks output from the file block processing module sequentially in an order of being read and decode contents of the file blocks;

a content pagination module configured to paginate the file blocks decoded by the content decoding module according to a display demand and to store their page table information; and

a display module configured to invoke an interface function of a BREW platform and to display the page to be read dependent upon the page table information stored by the content pagination module.

The reader further includes a display movement processing module configured to:

prepare for the display module both the page table information of a page to be read and of an adjacent page when the start position of the page to be read does not go beyond a range of the contents of the currently read file block; or

prepare for the display module the page table information of the page to be read and the adjacent page after the content decoding module and the content pagination module load and process the next file block when the start position of the page to be read goes beyond the range of the contents of the currently read file block.

The Txt file is of a type of the Windows platform, the Apple MAC platform or the Linux system.

An embodiment of the invention provides a mobile communication terminal including the Text file reader according to the second aspect of the embodiments of the invention.

Advantageous effects of the embodiments of the invention are as follows: for existing applications of electronic books, the embodiments of the invention further address the restriction on the size of a text file and perform functions of adaptive encoding and parsing and adaptive typesetting on a target file to enable diversified operations of and usages by a user.

### BRIEF DESCRIPTION OF THE DRAWINGS

FIG. 1 is a flow chart of a general process for a file block according to an embodiment of the invention;

FIG. 2 is a flow chart of adaptive decoding according to an embodiment of the invention;

FIG. 3 is a flow chart of text typesetting according to an embodiment of the invention;

FIG. 4a is a first schematic diagram of movement of a display position according to an embodiment of the invention;

FIG. 4b is a second schematic diagram of movement of a display position according to an embodiment of the invention;

FIG. 5 is a flow chart of moving a display position according to an embodiment of the invention;

FIG. 6 is a flow chart of displaying a text according to an embodiment of the invention;

FIG. 7 is a structural diagram of a first embodiment of a decoding device according to an embodiment of the invention;

FIG. 8 is a structural diagram of a second embodiment of a decoding device according to an embodiment of the invention;

FIG. 9 is a structural diagram of a first embodiment of a reader according to an embodiment of the invention; and

FIG. 10 is a structural diagram of a second embodiment of a reader according to an embodiment of the invention.

### DETAILED DESCRIPTION

Embodiments of the invention provide a method and device for decoding a Txt file and an electronic product including the device in order to address the problems of a capacity and a decoding speed in decoding of a Txt file.

Embodiments of the invention provide a method and reader for reading a Txt file based upon a Brew platform in order to address the problems of a restricted capacity and a restricted reading speed present in reading of a text in a handheld terminal.

Firstly, technical terms in the embodiments of the invention will be described briefly.

File block: preset-size file fragments to be analyzed into which a file is fragmentized, where the file is simply divided virtually into blocks without changing the size and structure of the original file.

Virtual pagination: pagination is performed by the preset largest number of lines that can be displayed and corresponding information of pages which may be different from actually displayed pages is stored.

Cache: a pre-allocated space for storing page table information of a fragment upon fetching the fragment, which is defined as a storage area for rapid reading and writing throughout the lifetime of program.

Hereinafter a method and device for decoding a Txt file and a method and reader for reading a Txt file will be described in details in several sections with reference to the drawings, where specific functions and operations will be represented as pseudocodes

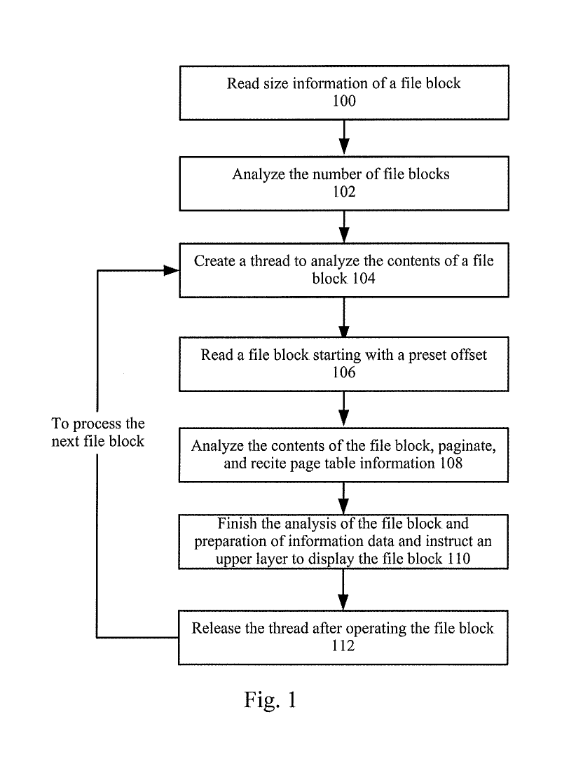

FIG. 1 illustrates a flow chart of a general process for a file block according to an embodiment of the invention, which as illustrated in FIG. 1 starts with an operation 100 of reading file size information, file_size=Getfilesize ( ).

In an operation 102, the number of file blocks is analyzed and counted according to a defined macro value Fragment_size, Frags=file_size/Fragment_size+1.

In an operation 104, a thread is created, Creat_thread, and is initialized, Init_thread, to start analyzing the contents of a file block, Thread_start.

In an operation 106, a file block is read starting with a preset offset, Read_block (start_position), where start_position is a defined offset.

In an operation 108, the contents of the file block are analyzed (that is, the contents of the text are decoded) and then paginated in a pagination function Block_pagescale ( ) page table information is recited in a global variable, i.e., Block_offset_recite, for storage, where the page table information includes the start offset of a page and the length of the page, and finally pagination is finished with a function Finish_pagingscale ( ).

In an operation 110, an event is sent, SendEvent ( ) to instruct an upper layer to display the file block after the file block is analyzed and the page table information is prepared.

In an operation 112, the thread is released, Release_thread ( ), after operating the file block.

As can be apparent from above, a method for decoding a Txt file according to an embodiment of the invention generally includes the following operations ‘a’ and ‘b’.

The operation ‘a’ is to divide virtually the Txt file into several file blocks by a preset macro value (which may range from 1 k to 1 M primarily dependent upon hardware).

The operation ‘b’ is to load the file blocks sequentially in an order of being decoded and decode the contents of the file blocks.

As can be apparent from above, a method and device for reading a Txt file based upon a Brew platform according to an embodiment of the invention generally includes the following operations ‘a’, ‘b’, ‘c’, and ‘d’.

The operation ‘a’ is to divide virtually the Txt file into several file blocks by a preset macro value (which may range from 1 k to 1 M primarily dependent upon hardware).

The operation b is to load the file blocks sequentially in an order of being read and decode the contents of the file blocks.

The operation c is to paginate the decoded file blocks and store their page table information according to a display demand (generally including the largest number of lines displayed per page and its correlated number of displayable pixel dots and size of a display font on a display screen).

The operation d is to invoke an interface function of a Brew platform and display a page to be read dependent upon the stored page table information.

In view of a correspondingly restricted file size due to hardware and in order for both a decoding speed and a reading speed to be independent of a file capacity, respective macro values for reading a file block are defined for different platforms in use. A different terminal can configure the magnitude of a macro value dependent upon its own software and hardware configuration.

In view of the characteristic of the Brew platform, a thread can be used for a reading operation to avoid the use of a temporally long cycle, which may result in abnormality due to another overtime task at a lower layer.

The contents of a corresponding text fragment are parsed by virtually paginating the contents of the fragment and storing the absolute start position of each block into a cache to avoid being parsed again upon being read and minimize a demand of the terminal for the capacity size of the cache.

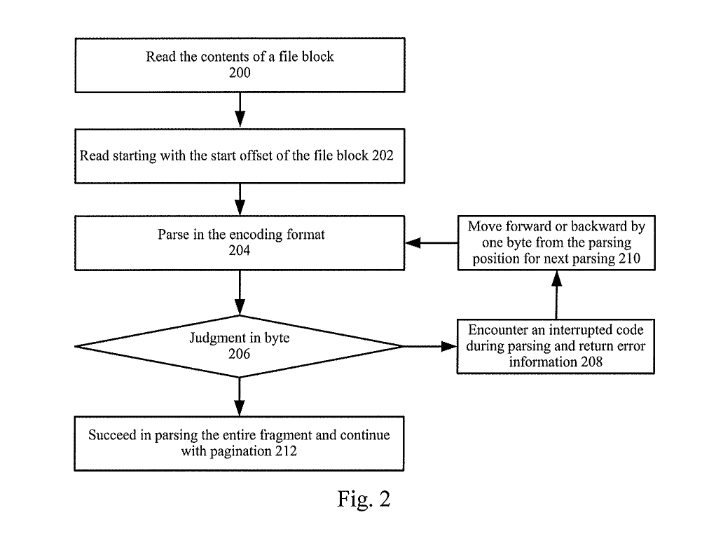

FIG. 2 illustrates a flow chart of adaptive decoding according to an embodiment of the invention, which as illustrated in FIG. 2 starts with an operation 200 of reading the contents of a file block and returning the read contents to a pointer defined as Pcontent so that Pcontent=Read_block (start_position).

In an operation 202, the contents of the file block are read starting with the start offset of the file block for decoding.

In the operation 204, an encoding format is determined and decoding is performed in the encoding format, that is, determination is made in an encoding format determination function Ntype=Get_codingtype (Pcontent) and then decoding is performed in a decoding function Ret=Coding_convention (Ntype, Pcontent), that is, codes are transcoded into a uniform code type, Unicode in the embodiment of the invention.

In the operation 206, the transcoded codes are judged in byte, Chars_judgement (Ret), and if an interrupted code is encountered during judgment in byte, then the flow goes to an operation 208 of returning error information; or if no interrupted code is encountered during judgment in byte, then the flow goes to an operation 212 of returning success information indicative of successful parsing of the entire fragment and continuing with pagination.

After the operation 208, the flow goes to an operation 210 of moving forward or backward by one byte from the parsing position for next parsing, that is, incrementing or decrementing automatically the pointer Pcontent by one, and then going back to the operation 104 of performing parsing again and the operations subsequent thereto.

For a differently encoded text file, each fragment is decoded by transcoding, and since common encoding schemes include GB2312/GBK, Unicode, Unicode-BE, Utf-8, etc., there are different encoding formats in which non-ASCII characters are included.

Since there is a corresponding flag bit in the head of a file (i.e., the very first several bytes of the file) encoded in Unicode, Unicode-BE and Utf-8, an encoding format can be determined from the corresponding contents read from the head of the file and then corresponding transcoding can be performed.

However there is no corresponding flag bit in the head of a text file stored in the encoding scheme of GB2312/GBK, the read contents thereof are parsed through code value control and judgment. The interrupted code problem is very likely to occur particularly in a jumping-enabled function, that is, the start position of a jump-to fragment is right at a lower bit of an encoded Chinese character (for example, “ [symbol] ” is represented in two hexadecimal bytes as “D6D0” in the GB codes, which means that D0 is read indeed, that is, the preceding byte “D6” is omitted), so that subsequent code values are moved, thus resulting in the problem of interrupted codes displayed as a corrupted text.

In view of the foregoing encoding problem, fine adaptive decoding is performed on any text fragment after being read in an embodiment of the invention.

As can be apparent from the encoding rule of the GB codes, an ASCII code value is represented in a single byte, and a non-ASCII code character, e.g., a Chinese character, etc., is represented in double bytes, where double bytes comply with a specific rule that the upper byte ranges from 80 to FE and the lower byte ranges from 40 to FE.

Furthermore a plurality of possibilities can be determined in decoding from double bytes preceding and succeeding to the read position in view of alternation between the characters encoded of the two lengths in a text (that is, an ASCII character of e.g., a punctuation (e.g., a line break, etc.,), etc., will necessarily be in a normal text, or if there is no corresponding symbol, then all of the contents is a text encoded in double bytes, and then it is simply needed to determine whether an offset is an even number). If no determination can be made, then some subsequent contents can be read until a corresponding ASCII character is encountered, that is, it can be determined whether there is a decoding error, and if so, then it indicates an interrupted code is encountered, which can be addressed here by moving the start position backward or forward by one byte.

In the embodiment of the invention, forward movement by one byte is adopted for seamless splicing of the text, and then the read contents are spliced seamlessly with a preceding fragment.

In the foregoing decoding process, a certain text block is selected and paginated in a thread, thus flexible jumping in the process can be well controlled to avoid the problem of controlling a variable due to a fragmentation and time division cycle.

Hereinafter a text typesetting process in a technical solution according to an embodiment of the invention will be described generally in terms of a line-breaking process.

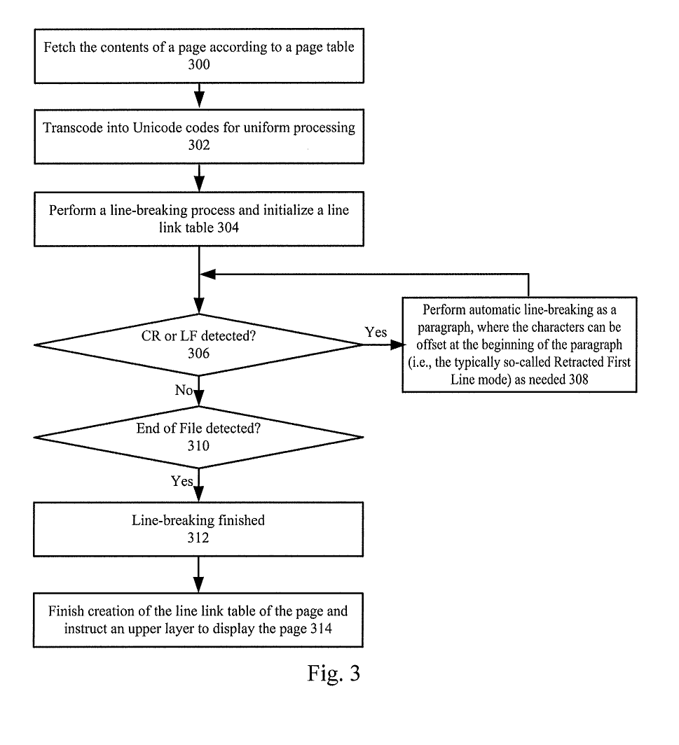

FIG. 3 illustrates a flow chart of text typesetting according to an embodiment of the invention, which as illustrated in FIG. 3 starts with an operation 300 of fetching the contents of a page according to page table information, where the contents of the page can be fetched by a content pointer after ascertaining the page table information of e.g., the start position of the page Page_start, the number of characters on the page, Page_char_num, etc., i.e., Pcontent=Read_content (Page_start, Page_char_num).

In an operation 302, the page is transcoded in a transcoding function PUnicode=code_convertion (Pcontent, Ntype) into Unicode characters for uniform processing.

In an operation 304, a line-breaking process is performed and a line link table is initialized, Plink=Init_link ( ).

In an operation 306, the characters of the page are judged, and when a CR or an LF is detected, the flow goes to an operation 308 of performing automatic line-breaking as a paragraph, where the characters can be offset at the beginning of the paragraph (i.e., the typically so-called Retracted First Line mode) as needed, particularly by adding the paragraph of characters to the line link table, the contents of which include a target link table, the start addresses of lines and the numbers of bytes in the lines, i.e., Add_link (Plink, line_start, line_cnt), and then the flow goes back to the operation 306 of performing the process again and performs subsequent operations.

In the operation 306, when neither CR nor LF is detected, the flow goes to the operation 310 of determining whether an End of File is detected, and this determination will occur only once at the end of the file.

In an operation 312, line-breaking is finished, Finish_scale (Plink), while passing the pointer Plink to a global variable.

In an operation 314, creation of the line link table of the page is finished, and an event is sent, SendEvent ( ) to instruct an upper layer to display the page.

Since the process is performed in the embodiment of the invention taking flexible display setting into account, the issue of text typesetting is crucial to free switching between a full screen and a non-full screen, a change to a font style, a font size, etc., as often used in a mobile terminal.

A varying character storage rule for use in a different PC platform is taken into full account in typesetting, and in this respect an adaptive process is performed and generally refers to representation of a line break, which is “CR+LF” in a text of the Windows platform, only “CR” in the Apple MAC system and “LF” in the Linux system, so it is necessary to provide a uniform and sufficiently adaptive format of a line break in a text generated in a varying system when the text is parsed.

Also in order for better display, the contents of each line for display on the terminal are recited in a link table similarly to the process for the page table information, and thus a correlated display process can be line-specific to facilitate free switching between reading modes and other diversified operations in reading.

In the technical solution according to the embodiment of the invention, the text typesetting process is similar to an implementation of an “automatic line-breaking” function in a Chinese text reader on a PC to enable a text to be automatically and fully displayed on a current screen in view of the width of the screen without incurring the problems of e.g., non-full display of a too long paragraph, etc., or necessitating an operation of dragging a scrolling bar.

A font can be changed simply by altering a font size in a character string measurement function, so the font size can be fully de-correlated in pagination.

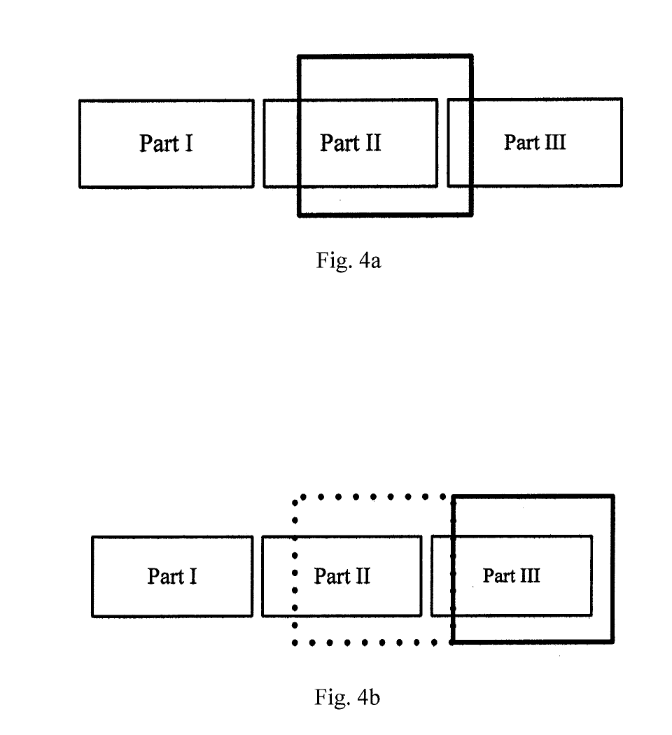

FIG. 4a and FIG. 4b illustrate schematic diagrams of movement of a display position according to an embodiment of the invention, and as illustrated in FIG. 4a and FIG. 4b, a window with a bold perimeter shows the contents of a text currently displayed on a screen, and three displayed fragments represent respectively information of three texts loaded at a time into a memory.

Here information of only a line offset after line-breaking is stored instead of loading the contents of an actual text block, and the currently shadowed window is moved forward or backward for line-scrolling up or down or page up or down.

The foregoing movement includes two movement modes:

one mode refers to display movement of between pages in a file block; and

the other mode refers to display movement of a page between file blocks.

Here they are referred collectively to as a display fragment, that is, the display fragment can represent a different file block or a different page in a file block.

Hereinafter a process of switching a display fragment will be described in general.

A display fragment will be switched when the shadowed window is moved to the status of the upper figure, that is, the start position of the shadowed window has gone beyond a middle text display fragment.

Specifically, information of a leading fragment is released and an information link of a next fragment is supplemented subsequent to a tailing fragment so that the original tailing fragment is placed as the middle fragment, the original middle fragment is placed as a leading fragment and the newly added fragment is placed as a tailing fragment to thereby ensure display contents will be positioned information-overlapping with the middle fragment, that is, there is a non-blank context throughout the process.

The foregoing process is actually intended to ensure direct reading of line information of display contents on a next page each time action of page up or down or line-scrolling up or down is performed.

Thus it is also possible to avoid the problem of a corrupted text easily occurring upon scrolling forward (i.e., page up or line-scrolling up) after decoding of a fragment in a traditional operation. Since the majority of numerous encoding schemes of non-ASCII code characters are inconsistent with the encoding length of ASCII, the problem of an interrupted code and consequently the corresponding problem of a corrupted text will easily occur due to incorrect determination of encoding in forward reading of text contents.

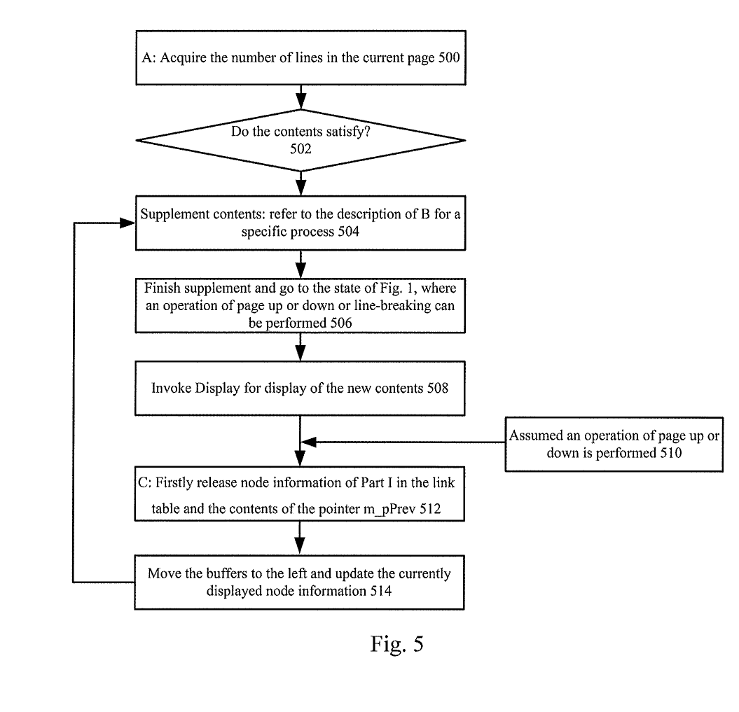

FIG. 5 illustrates a flow chart of movement of a display position according to an embodiment of the invention, which as illustrated in FIG. 5 completely depicts the process flow.

Firstly three buffers are defined respectively as:

m_pPrev (which represents a text in Part I);

m_pMiddle (which represents a text in Part II);

m_pNext (which represents a text in Part III);

And a link table: Link*m_LineLink, m_pCurrentNode.

The following items are stored in a link node:

1. the start position of a pointer to the text contents of a line-pText; and

2. the number of bytes in the line-nLength.

Assumed the number of lines that can be displayed per page on the current terminal is LINE_PER-PAGE; and

All of link-related operation functions start with Link_.

This part involves several important processes:

A.

nCurrentCnt=Link_GetCount (&m_LineLink);

This results in the number of lines in the current link table.

B.

Contents will be supplemented if the contents in the current link table are insufficient up to three pages (assumed they are currently positioned in the middle fragment of the text instead of being displayed to the end).

If (nCurrentCnt < 2 * LINE_PER_PAGE)
{
Uint16 nPageOffset, nPageCnt;
//A variable is temporarily defined in order to fetch the start offset

position of and the number of characters on the page

Link * pNewPageLink;
//Pointer to line information of a newly loaded page
GetNextPageInfo (&nPageOffset, &nPageCnt);
//Fetch the start offset position of the contents of a next page and the

number of characters included on this page

pNewPageLink = PageLoad (m_pNext, nPageOffset, nPageCnt);
//The contents of the next page are loaded and the contents of the line

information of this page are formed as a link table and returned

Link_Add (&m_LineLink, pNewPageLink);
//A line link table of the currently fetched new page is added at the

end of a global link table

}

C.

Assumed the start position of the currently displayed page is as illustrated in FIG. 4a and at a line node m_pCurrentNode.

Page down is now assumed, and then the status of the pages is changed to that as illustrated in FIG. 4b:

As can be apparent, the contents of the next page can not be fully displayed for now, so Part I will be released prior to page down, Part II and Part III will be forwarded sequentially as Part I and Part II, and finally the next page will be loaded and added into the link table and the contents of the relevant variables will be set to the appropriate current positions.

A specific flow is as follows:

```
If (FALSE == JudgeLinkLeft (&m_LineLink, m_pCurrentNode))
{
  FreeHeadPart (&m_LineLink, LINE_PER_PAGE)
//Nodes of Part I in the link table are released
  Free_Buffer (m_pPrev)
//A pointer to the contents of Part I is released
  MoveBuffer_To_Left (m_pPrev, m_pMiddle, m_pNext)
//Pointers to the buffers are moved to the left
//Reference is made to Section B for a specific process of loading the
next page
}
m_pCurrentNode = LinkGetNext
(&m_LineLink, LINE_PER_PAGE)
//Move backward from the current node by the number of nodes in
```

the number of lines per page to the position of a node from which the next
page is displayed

Display (&m_LineLink, m_pCurrentNode)
//The contents of the next page are displayed from the position to

which pCurrentNode points, and a specific implementation of the function
Display has been described.

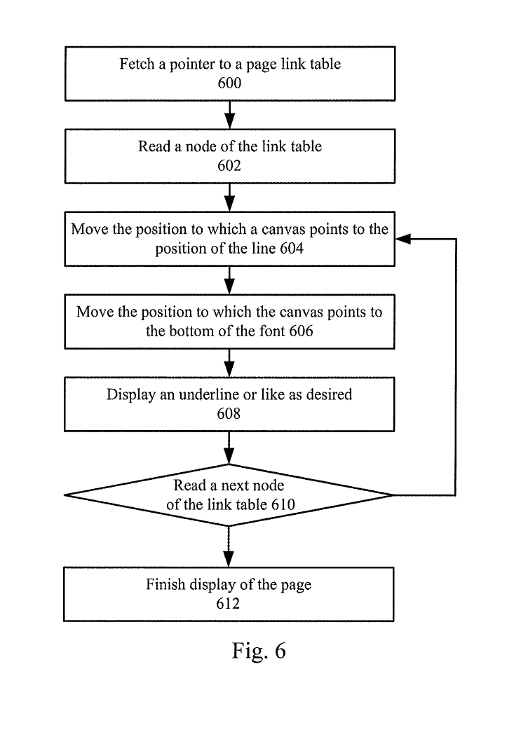

FIG. 6 illustrates a flow chart of displaying a text according to an embodiment of the invention, which as illustrated in FIG. 6 starts with an operation 600 of fetching a pointer to a page link table, Plink=Get_page_link ( ), and reading the link table from a leading node.

In an operation 602, a node of the link table is read, Pnode=Get_link_start (Plink).

In an operation 604, the position to which a canvas points is moved to the position of the line:

Idisplay_setclip (Pdisplay, position), where the position is initialized to 0;

Idisplay_drawtext (Pdisplay, Pnode_text).

In an operation 606, the height of a font is added, Position=position+Font−Height, and then the position to which the canvas points is moved to the bottom of the font, Idisplay_moveto (Pdisplay, position).

In an operation 608, an underline or like is displayed as desired, Idisplay_Drawline (Pdisplay).

In an operation 610, it is determined whether a next node of the link table is read, Pnode=Get_next (Plink, Pnode), and if so, then the flow returns to the operation 604 of moving again and performs the subsequent operations; otherwise, the flow goes to an operation 612 of finishing display of the page, and the foregoing process ends.

In the embodiment of the invention, since the public interface functions of the Brew platform are invoked for display of a font, this application can enable all of the display functions of a text subject and can make use of diversified display setting to display a user customized font color and background color and also accommodate required display of an additional format of e.g., an underline, a dotted line, etc.

Since the contents have been decoded and stored in the line link table when the file block is parsed, a specific line with a position from which the display is presented can be determined simply by placing the start position at a corresponding node of the link table, and then respective lines can be drawn on the screen at the corresponding positions dependent upon the size of a display area by invoking the Brew public interface functions of displaying a font. When each of the lines are drawn, an addition process can be performed dependent upon the display contents of accessories in current setting, for example, if the current line shall be underlined, then a straight line can be drawn in the Brew public interface function under the corresponding position after the font has been displayed.

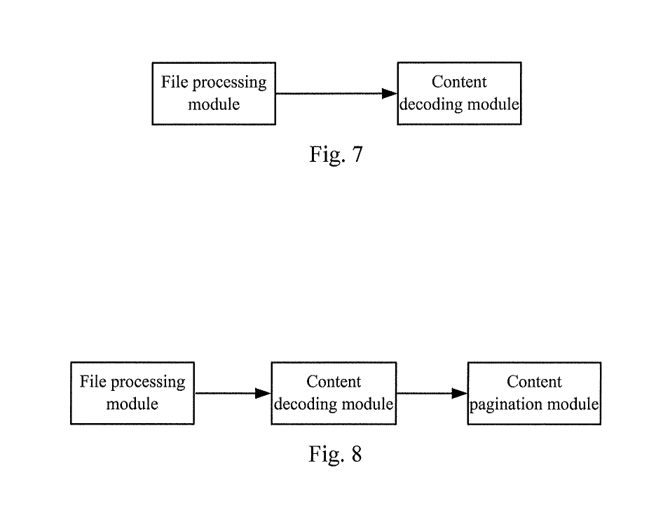

FIG. 7 illustrates a structural diagram of a first embodiment of a decoding device according to an embodiment of the invention, which as illustrated in FIG. 7 includes a file block processing module and a content decoding module, where:

The file block processing module is configured to virtually divide a Txt file into several file blocks by a preset macro value.

The content decoding module is configured to load the file blocks output from the file block processing module sequentially in an order of being decoded and decode the contents of the file blocks.

FIG. 8 illustrates a structural diagram of a second embodiment of a decoding device according to an embodiment of the invention, which as illustrated in FIG. 8 includes a file block processing module, a content decoding module and a content pagination module, where:

The file block processing module is configured to virtually divide a Txt file into several file blocks by a preset macro value.

The content decoding module is configured to load the file blocks output from the file block processing module sequentially in an order of being decoded and decode the contents of the file blocks.

The content pagination module is configured to paginate the file blocks decoded by the content decoding module according to a display demand and to store their page table information.

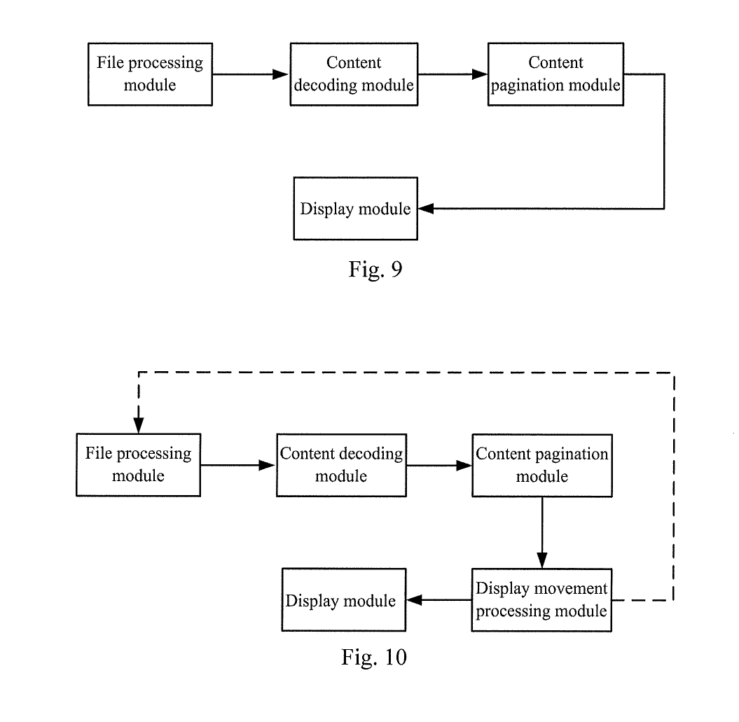

FIG. 9 illustrates a structural diagram of a first embodiment of a reader according to an embodiment of the invention, which as illustrated in FIG. 9 includes a file block processing module, a content decoding module, a content pagination module and a display module, where:

The file block processing module is configured to virtually divide a Txt file into several file blocks by a preset macro value.

The content decoding module is configured to load the file blocks output from the file block processing module sequentially in an order of being read and decode the contents of the file blocks.

The content pagination module is configured to paginate the file blocks decoded by the content decoding module according to a display demand and to store their page table information.

The display module is configured to invoke an interface function of a Brew platform and to display a page to be read dependent upon the page table information stored by the content pagination module.

The content pagination module in FIG. 7, FIG. 8 and FIG. 9 further performs the following processes:

fetching the decoded file blocks and transcoding the contents of the file blocks into Unicode characters; and

performing a line-breaking process upon detection of a CR or an LF in the Unicode characters of the file blocks.

The Txt file can be of a type of the Windows platform, the Apple MAC platform or the Linux system.

Decoding in the content decoding module can be of a type of one or more of:

GB2312/GBK, Unicode, Unicode-BE and Utf-8.

FIG. 10 illustrates a structural diagram of a second embodiment of a reader according to an embodiment of the invention, which as illustrated in FIG. 10 includes a file block processing module, a content decoding module, a content pagination module, a display movement processing module and a display module, where:

The file block processing module is configured to virtually divide a Txt file into several file blocks by a preset macro value.

The content decoding module is configured to load the file blocks output from the file block processing module sequentially in an order of being read and decode the contents of the file blocks.

The content pagination module is configured to paginate the file blocks decoded by the content decoding module according to a display demand and to store their page table information.

The display movement processing module is configured to prepare for the display module the page table information of both a page to be read and an adjacent page when the start position of the page to be read does not go beyond the range of the contents of the currently read file block.

Or prepare for the display module the page table information of the page to be read and the adjacent page after the content decoding module and the content pagination module load and process the next file block when the start position of the page to be read goes beyond the range of the contents of the currently read file block.

The display module is configured to invoke an interface function of a Brew platform and to display the page to be read dependent upon the page table information stored by the content pagination module.

The content pagination module further performs the following processes:

fetching the decoded file blocks and transcoding the contents of the file blocks into Unicode characters; and

performing a line-breaking process upon detection of a CR or an LF in the Unicode characters of the file blocks.

The Txt file can be of a type of the Windows platform, the Apple MAC platform or the Linux system.

Decoding in the content decoding module can be of a type of one or more of:

GB2312/GBK, Unicode, Unicode-BE and Utf-8.

In view of that there are an increasing number of existing portable electronic products (including a cellular phone, an electronic dictionary, a PDA, an MP3, an MP4, etc.) and applications of electronic books for use in mobile terminals and an increasing amount of current information, the existing portable electronic products for different platforms and cellular phone terminals based upon a Brew platform, particularly low- to mid-end cellular phones, suffer from restricted decoding of a text file and consequential restricted reading of an electronic book in a text file and their functions have been not perfect; and the traditional approach of direct loading, decoding and typesetting has failed to accommodate the current application demand and can not offer a perfect support for diversified operations of a user. The technical solution herein can address a restricted size of the capacity of a text file to be read on a terminal and support operations of e.g., self-adaptation to various encoding formats, automatic optimization of typesetting, arbitrary jumping, page up or down, etc.

In view of the foregoing problems, the technical solution herein has been devised without restricting the size of a target file and with an opening speed thereof independent of the size of the file to support diversified display and typesetting as required, and such an innovation of the processing architecture can achieve such functions of parsing and typesetting any Txt file, fundamental operation of supporting switching the size of a font in response to an interruption, altering the color of a font and the color of the background, etc., and also support diversified operations of a user for browsing the file.

The foregoing detailed description of the embodiments of the invention is intended to illustrate but not to limit the embodiments of the inventive solution. Those ordinarily skilled in the art benefiting from the teaching of the embodiments of the invention can make various variations to the embodiments described above, and these variations shall come into the scope of the embodiments of the invention as defined in the appended claims.

1. A method for decoding a Txt file, comprising:
an operation ‘a’ of virtually dividing a Txt file into several file blocks by a preset macro value; and
an operation ‘b’ of loading the file blocks sequentially in an order of being decoded and decoding contents of the file blocks.

2. The method for decoding a Txt file according to claim 1, wherein after the operation ‘b’, the method further comprises an operation ‘c’ of:
paginating the decoded file blocks and storing their page table information.

3. The method for decoding a Txt file according to claim 1, wherein before paginating the decoded file blocks, the operation ‘c’ further comprises:
an operation ‘c1’ of fetching the decoded file blocks and transcoding the contents of the file blocks into Unicode characters; and
an operation ‘c2’ of performing a line-breaking process upon detection of a CR or an LF in the Unicode characters of the file blocks.

4. The method for decoding a Txt file according to claim 3, wherein the Txt file is encoded of a type of one or more of:
GB2312/GBK, Unicode, Unicode-BE and Utf-8.

5. The method for decoding a Txt file according to claim 4, wherein:
the file blocks are processed in a thread which is terminated after the file blocks are decoded and/or paginated and stored.

6. A method for reading a Txt file based upon a Brew platform, comprising:
an operation ‘a’ of virtually dividing a Txt file into several file blocks by a preset macro value;
an operation ‘b’ of loading the file blocks sequentially in an order of being read and decoding contents of the file blocks;
an operation ‘c’ of paginating the decoded file blocks according to a display demand and storing their page table information; and
an operation ‘d’ of invoking an interface function of the Brew platform and displaying a page to be read dependent upon the stored page table information.

7. The method for reading a Txt file according to claim 6, wherein after the operation ‘c’ and before the operation ‘d’, the method further comprises an operation ‘e’ of:
determining whether a start position of the page to be read goes beyond of a range of contents of a currently read file block; and
if so, then going to the operation ‘d’;
otherwise, going back to the operation ‘b’ and performing the subsequent operations again.

8. The method for reading a Txt file according to claim 6, wherein the file blocks are processed from the operation ‘b’ in a thread which is terminated after the file blocks are decoded, paginated and stored.

9. The method for reading a Txt file according to claim 8, wherein before paginating the decoded file blocks, the operation ‘c’ further comprises:
an operation ‘c1’ of fetching the decoded file blocks and transcoding the contents of the file blocks into Unicode characters; and
an operation ‘c2’ of performing a line-breaking process upon detection of a CR or an LF in the Unicode characters of the file blocks.

10. The method for reading a Txt file according to claim 9, wherein the interface function of the Brew platform invoked in the operation ‘d’ comprises one or more of:
a font color, a background color, an underline and a dotted line.

11. A device for decoding a Txt file, comprising:
a file block processing module configured to virtually divide a Txt file into several file blocks by a preset macro value; and
a content decoding module configured to load the file blocks output from the file block processing module sequentially in an order of being decoded and decode contents of the file blocks.

12. The device for decoding a Txt file according to claim 11, further comprising a content pagination module configured to paginate the file blocks decoded by the content decoding module and to store their page table information.

13. The device for decoding a Txt file according to claim 12, wherein the content pagination module is further configured to:
fetch the decoded file blocks and transcode the contents of the file blocks into Unicode characters; and
perform a line-breaking process upon detection of a CR or an LF in the Unicode characters of the file blocks.

14. The device for decoding a Txt file according to claim 11, wherein the device is comprised in an electronic product.

15. The device for decoding a Txt file according to claim 14, wherein:
the electronic product is a cellular phone, an electronic dictionary, a PDA, an MP3, or an MP4.

16. (canceled)

17. (canceled)

18. (canceled)

19. (canceled)

20. (canceled)

21. The method for decoding a Txt file according to claim 2, wherein before paginating the decoded file blocks, the operation ‘c’ further comprises:
an operation ‘c1’ of fetching the decoded file blocks and transcoding the contents of the file blocks into Unicode characters; and
an operation ‘c2’ of performing a line-breaking process upon detection of a CR or an LF in the Unicode characters of the file blocks.

22. The method for decoding a Txt file according to claim 21, wherein the Txt file is encoded of a type of one or more of:
GB2312/GBK, Unicode, Unicode-BE and Utf-8.

23. The method for decoding a Txt file according to claim 22, wherein:
the file blocks are processed in a thread which is terminated after the file blocks are decoded and/or paginated and stored.

24. The method for reading a Txt file according to claim 7, wherein the file blocks are processed from the operation ‘b’ in a thread which is terminated after the file blocks are decoded, paginated and stored.

25. The method for reading a Txt file according to claim 24, wherein before paginating the decoded file blocks, the operation ‘c’ further comprises:
an operation ‘c1’ of fetching the decoded file blocks and transcoding the contents of the file blocks into Unicode characters; and
an operation ‘c2’ of performing a line-breaking process upon detection of a CR or an LF in the Unicode characters of the file blocks.
